(19) United States
(12) Patent Application Publication
(10) Pub. No.: US 2003/0160998 A1
(43) Pub. Date: Aug. 28, 2003

(54) Communication system, computer program, and communication device

(75) Inventor: Tetsuya Kuwahara, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/359,813

(22) Filed: Feb. 7, 2003

(30) Foreign Application Priority Data
Feb. 22, 2002 (JP) 2002-046712
Feb. 27, 2002 (JP) 2002-051528

(51) Int. Cl. G06F 15/00; B41J 1/00

(52) U.S. Cl. 358/1.15

(57) ABSTRACT

A communication system includes a transmitter that transmits formed data formed by an information device or converted data of which a format of the formed data is converted, to a receiving device via a communication device. The information forming device includes a processor that determines an ability of the receiving device and a controller that selects either the formed data or the converted data in accordance with the determined ability and outputs the selected data to the communication device.

### FIELD OF THE INVENTION

The present invention relates to a communication system for communicating image information formed by a information forming device such as a personal computer (hereinafter referred to as PC), a computer program for outputting the image information by a computer, and a communication device for transmitting the image information to a receiving device such as a facsimile machine.

### DESCRIPTION OF THE RELATED ART

A multi-function facsimile machine is being developed, wherein the facsimile machine is connected to the PC via a communication line, and includes a transmitting function for transmitting image information transmitted from the PC to another facsimile machine, and a printer function for printing out the image information, in addition to the conventional copying and facsimile functions.

### SUMMARY OF THE INVENTION

The present invention was made in consideration to the above-described circumstance. An advantage of the present invention is to provide a communication system and a computer program that can eliminate the interpretation function for Page Description Language (PDL) data in a relay communication device.

Another advantage of the present invention is to provide a communication device that can transmit image information from the image forming device such as the PC to a receiving device specified by the destination information, without having the interpretation function for the PDL data.

Furthermore, another advantage of the present invention is to provide a communication device that can carry out an appropriate processing according to the ability of the receiving device (facsimile machine).

The communication system according to a first aspect of the present invention is a communication system that transmits formed data formed by an information forming device or converted data of which a format of the formed data is converted, to a receiving device via a communication device. The information forming device includes a determining unit which determines the ability of the receiving device. In addition, the information forming device includes a selecting unit which selects either the formed data or the converted data in accordance with the determined ability and outputs the selected data to the communication device.

According to the first aspect, the information forming device determines the ability of the receiving device. Then, the information forming device outputs data to the communication device according to the determined ability. That is, the information forming device outputs the PDL data to the communication device under a format as is, or outputs the PDL data converted into another format to the communication device according to the ability of the receiving device for the formed image information (PDL data) described in the PDL. Therefore, since a processing corresponding to the ability of the receiving device is completed at the information forming device such as the PC, even when the receiving device is a communication device that does not include an interpretation function for the PDL, the transmission to the receiving device specified by the destination information can be carried out smoothly.

The computer program according to a second aspect of the present invention is a computer program including the step of outputting communication data based on image information to be transmitted to the receiving device to the communication device by a computer connected to the communication device. In addition, the computer program includes the steps of determining the ability of the receiving device by the computer, and deciding on a format of the communication data by the computer in accordance with the determined ability.

According to the second aspect, the ability of the receiving device is determined, and the communication data corresponding to the determined ability is output to the communication device. Therefore, since the communication data corresponds to the ability of the receiving device, even when the communication device that does not include an interpretation function for the PDL is used, the transmission to the receiving device specified by the destination information can be carried out smoothly.

According to a third aspect of the present invention, the computer program according to the second aspect further includes the step of determining whether or not the receiving device can support the PDL by a computer. In addition, the computer program includes the step of outputting the image information described in the PDL as the communication data to the communication device by the computer when the receiving device can support the PDL.

According to the third aspect, when the receiving device can support the PDL data, the input PDL data is output to the communication device under the format as is. Therefore, the communication device that does not include the interpretation function for the PDL can be used as the relay communication device.

According to a fourth aspect of the present invention, the computer program according to the third aspect further includes the step of converting the image information described in the PDL into an image data corresponding to a resolution of the receiving device by the computer when the receiving device cannot support the PDL. In addition, the computer program includes the step of outputting the converted image data as the communication data to the communication device.

According to the fourth aspect, when the receiving device cannot support the PDL data, the input PDL data is converted into an image data corresponding to a resolution of the receiving device, and the image data is output to the communication device. Therefore, the relay communication device is not required to convert the PDL data into the image data. In addition, the communication device that does not include the interpretation function for the PDL can also be used as the relay communication device. Furthermore, the communication device is not required to have the resolution conversion function.

According to a fifth aspect of the present invention, the computer program according to the third aspect further includes the step of converting the image information described in the PDL into an image data by a computer when the receiving device cannot support the PDL. In addition, the computer program includes the step of outputting the converted image data as the communication data to the communication device by the computer.

According to the fifth aspect, when the receiving device cannot support the PDL data, the input PDL data is converted into image data, and the image data is output to the communication device. Therefore, the relay communication device is not required to convert the PDL data into the image data. In addition, the communication device that does not have the interpretation function for the PDL can be used as the relay communication device.

The communication device according to a sixth aspect of the present invention is a communication device which is input with the image information or the image data converted from the image information and the destination information from the image forming device that forms the image information described in the page description language. In addition, the communication device transmits the image information or the image data to the receiving device specified by the destination information. The communication device includes a transmitting unit for transmitting the ability of the receiving device to the information forming device.

According to the sixth aspect, the communication device obtains the ability of the receiving device from the communication protocol with the receiving device. Then, the communication device outputs the obtained ability information to the information forming device. Therefore, since the information forming device can obtain the ability of the receiving device, the communication data suitable for the ability of the receiving device is output to the communication device in the next transmission.

According to a seventh aspect of the present invention, the communication device according to the sixth aspect further includes a transmitting unit for transmitting the image information to the receiving device when the image information is input from the information forming device. In addition, the communication device includes an execution unit for executing a resolution conversion processing to the image data in accordance with a resolution of the receiving device obtained from a communication protocol with the receiving device, and transmitting the image data to the receiving device when the image data is input from the information forming device.

According to the seventh aspect, when the PDL data is input from the information forming device, the communication device transmits the PDL data as is, to the receiving device specified by the destination information. When the image data is input, the communication device executes a resolution conversion processing to the image data according to the resolution of the receiving device specified by the destination information, and transmits the image data to the receiving device. Therefore, the communication device is required to include the resolution conversion processing function. The communication device is not required to include the interpretation function for the page description function.

The communication device according to an eighth aspect of the present invention includes an inputting unit for inputting communication data described in the PDL. In addition, the communication device includes an obtaining unit for obtaining destination information of the input communication data. The communication device also includes a determining unit for determining whether or not a receiving device specified by the destination information can support the PDL. Furthermore, the communication device includes a transmitting unit for transmitting the input communication data to the receiving device when the specified receiving device can support the PDL.

According to the eighth aspect, the communication device inputs the communication data (PDL data) described in the PDL, and obtains the destination information of the PDL data. Then, the communication device determines whether or not the receiving device specified by the destination information can support the PDL data. When the receiving device can support the PDL data, the communication device transmits the PDL data as, is to the receiving device. Therefore, the PDL data can be transmitted as is, and the time required for the transmission processing can be shortened.

According to a ninth aspect of the present invention, the communication device according to the eighth aspect further includes a determining unit for determining whether or not the receiving device can support a resolution of the communication data when the receiving device cannot support the PDL. The communication device also includes a conversion unit for converting the input communication data into image data when the receiving device can support the resolution. In addition, the communication device includes a transmitting unit for transmitting the converted image data to the receiving device under the resolution of the communication data.

According to the ninth aspect, when the receiving device cannot support the PDL data, the communication device determines whether or not the receiving device can support the resolution of the PDL data. When the receiving device can support the resolution of the PDL data, the communication, device converts the PDL data into image data, and transmits the converted image data to the receiving device under the resolution of the PDL data. Therefore, the resolution conversion processing becomes unnecessary, and the processing efficiency can be improved. In addition, the receiving device can print the image data under high image quality without deteriorating the resolution.

According to a tenth aspect of the present invention, the communication device according to the ninth aspect further includes a conversion unit for converting the input communication data into image data corresponding to the resolution of the receiving device when the receiving device cannot support the resolution of the communication data. In addition, the communication device includes a transmitting unit for transmitting the converted image data to the receiving device.

According to the tenth aspect, when the receiving device cannot support the resolution of the PDL data, the communication device converts the PDL data into the image data corresponding to the resolution of the receiving device. Then, the communication device transmits the converted image data to the receiving device. Therefore, the communication device can transmit the image data suitable to the resolution of the receiving device, and the processing efficiency can be improved.

According to an eleventh aspect of the present invention, the communication device according to the eighth aspect further includes a conversion unit for converting the input communication data into image data corresponding to a prescribed resolution when the fact of whether or not the receiving device can support the PDL is unclear. In addition, the communication device includes a transmitting unit for transmitting the converted image data to the receiving device.

According to the eleventh aspect, when the receiving device specified by the destination information is unknown, the communication device converts the PDL data into the image data corresponding to a prescribed resolution. Then, the communication device transmits the converted image data to the receiving device. Therefore, even when the ability of the destination is unknown, an appropriate processing can be executed.

### BRIEF DESCRIPTION OF THE DRAWINGS

FIG. 1 is a schematic diagram showing an entire configuration of a system according to the first and second embodiments of the present invention.

FIG. 2 is a block diagram showing the configuration of the facsimile machine (communication device) according to the first and second embodiments of the present invention.

FIG. 3 is a functional block diagram of the PC (information forming device) according to the first and second embodiments of the present invention.

FIG. 4 is a flowchart showing the processing procedure at the PC side according to the first embodiment.

FIG. 5 is a flowchart showing the processing procedure at the facsimile machine side according to the first embodiment.

FIG. 6 is a flowchart showing the processing procedure at the PC side according to the second embodiment.

FIG. 7 is a flowchart showing the processing procedure at the facsimile machine side according to the second embodiment.

FIG. 8 is a block diagram showing the configuration of the facsimile machine (communication device) according to the third embodiment of the present invention.

FIG. 9 is a flowchart showing the operation procedure of the facsimile machine (communication device) according to the third embodiment of the present invention.

FIG. 10 is a flowchart showing the operation procedure of the facsimile machine (communication device) according to the third embodiment of the present invention.

### DETAILED DESCRIPTION OF THE PREFERRED EMBODIMENTS

The first and second embodiments of the present invention will be described with reference to the accompanying drawings.

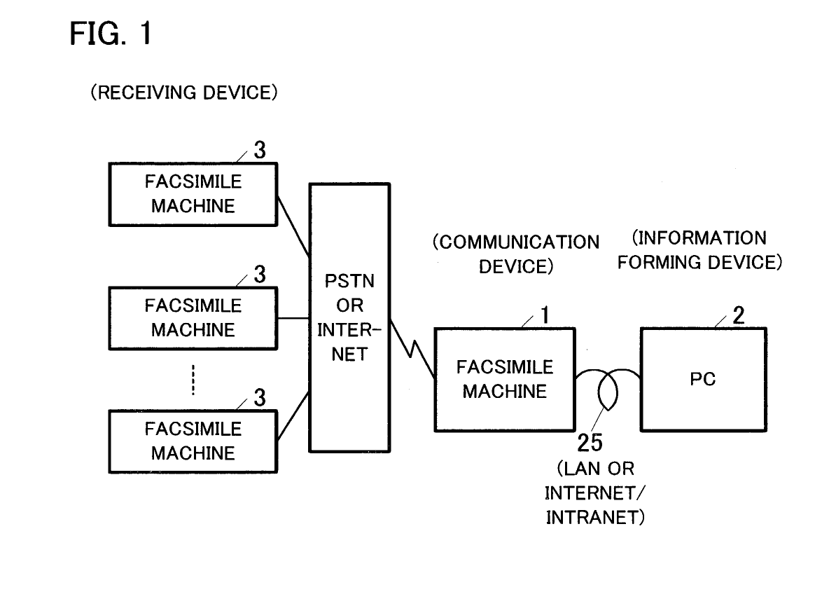

FIG. 1 is a schematic diagram showing the entire configuration of a system according to the present invention. In FIG. 1, reference number 1 is a facsimile machine as a communication device of the present invention. Reference number 2 is a personal computer (PC) as an information forming device. The facsimile machine 1 and the PC 2 are connected via a communication line 25. The facsimile machine 1 transmits and receives image data via a telephone network in both directions with a plurality of facsimile machines 3, 3, . . . , 3 as receiving devices.

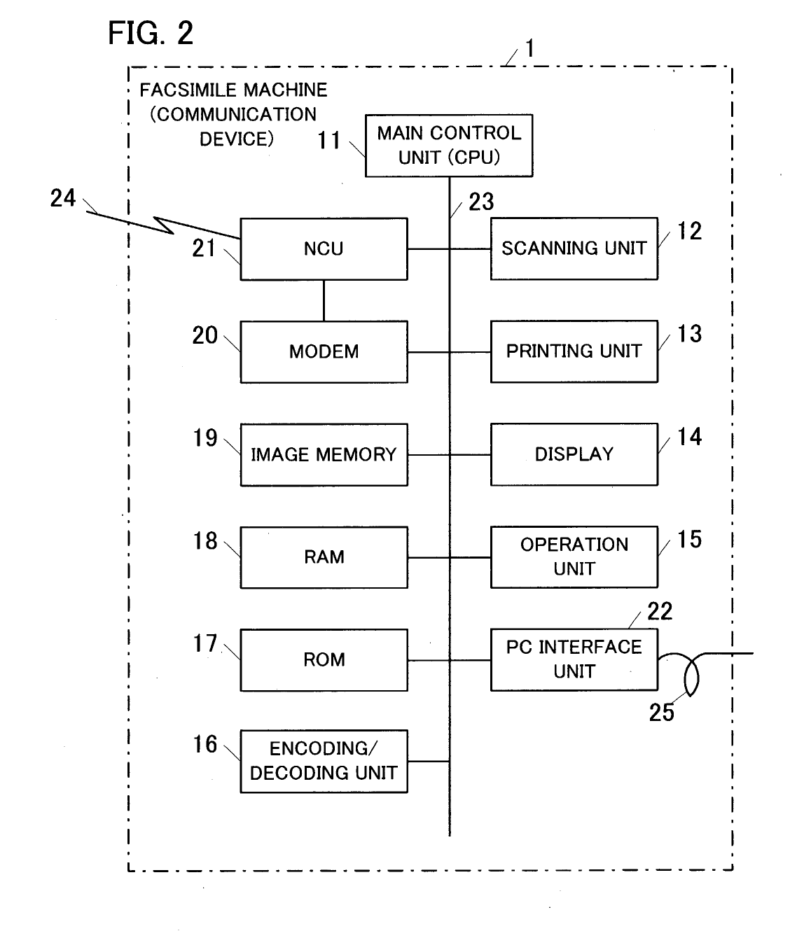

FIG. 2 is a block diagram showing a configuration of the facsimile machine 1 of the present invention. The facsimile machine 1 includes a main control unit 11, a scanning unit 12, a printing unit 13, a display 14, an operation unit 15, an encoding/decoding unit 16, a Read Only Memory (ROM) 17, a Random Access Memory (RAM) 18, an image memory 19, a modem 20, a Network Control Unit (NCU) 21, and PC interface unit 22 or the like. The facsimile machine 1 includes conventional facsimile functions and copying functions. In addition, the facsimile machine 1 includes a transmitting function for transmitting communication data being transmitted from the PC 2 to the facsimile machine 3 of a desired destination by making a connection to the PC 2. However, the facsimile machine 1 of the present invention does not have an interpretation function for the PDL, in other words, the PDL data.

The main control unit 11 is formed from a Central Processing Unit (CPU) specifically. The main control unit 11 is connected to each of the above-mentioned hardware units of the facsimile machine 1 via a bus 23, and controls each of the hardware units. In addition, the main control unit 11 executes various software functions in accordance with a control program stored in the ROM 17. The scanning unit 12 scans an original document/image using a Charge-Coupled Device (CCD) or the like. In addition, the scanning unit 12 outputs the scanned image data. The printing unit 13 is an electro-photographic printing device. For example, the printing unit 13 prints out an image data received by a facsimile communication, the image data of the original scanned by the scanning unit 12, and communication data transmitted from the PC 2.

The display 14 is a displaying device such as a Liquid Crystal Display (LCD) or a Cathode Ray Tube (CRT) display. For example, the display 14 displays an operation status of the facsimile machine 1, the image data of the original document/image scanned to be transmitted, an image data received from another facsimile machine 3, and the communication data transmitted from the PC 2. The operation unit 15 includes letter keys, ten-key numeric pad, speed dial keys, one-touch dial keys, and various function keys or the like that are necessary for operating the facsimile machine 1. Further, by forming the display 14 as a touch panel, a part or all of the various keys within the operation unit 15 can be substituted. The encoding/decoding unit 16 encodes and compresses an image signal, and decodes the encoded and compressed image data into an original image signal.

The ROM 17 stores in advance various software programs that are necessary for the operation of the facsimile machine 1. The RAM 18 is formed from a Static Random Access Memory (SRAM), a flash memory or the like. The RAM 18 stores temporary data that is generated when the software is executed. The image memory 19 is formed from a Dynamic Random Access Memory (DRAM) or the like. For example, the image memory 19 accumulates the image data scanned to be transmitted, the image data received from other facsimile machine 3, and the communication data transmitted from the PC 2.

The modem 20 is connected to the bus 23. The modem 20 is formed from a facsimile modem that can carry out the facsimile communication. Moreover, the modem 20 is connected directly to the NCU 21 that is also connected to the bus 23 in the same way. The NCU 21 is hardware for carrying out a closing and a releasing operation of a line 24 between the NCU 21 and the telephone network. The NCU 21 connects the modem 20 and the telephone network when necessary.

The PC interface unit 22 is connected to the PC 2 (facsimile interface unit 37 to be described later on) via the communication line 25. The PC interface 22 exchanges data with the PC 2. In addition, the PC interface unit 22 analyzes a command from the PC 2, and executes processing based on the analyzed result. In addition, when necessary, the PC interface 22 executes resolution conversion processing to the image data transmitted from the PC 2.

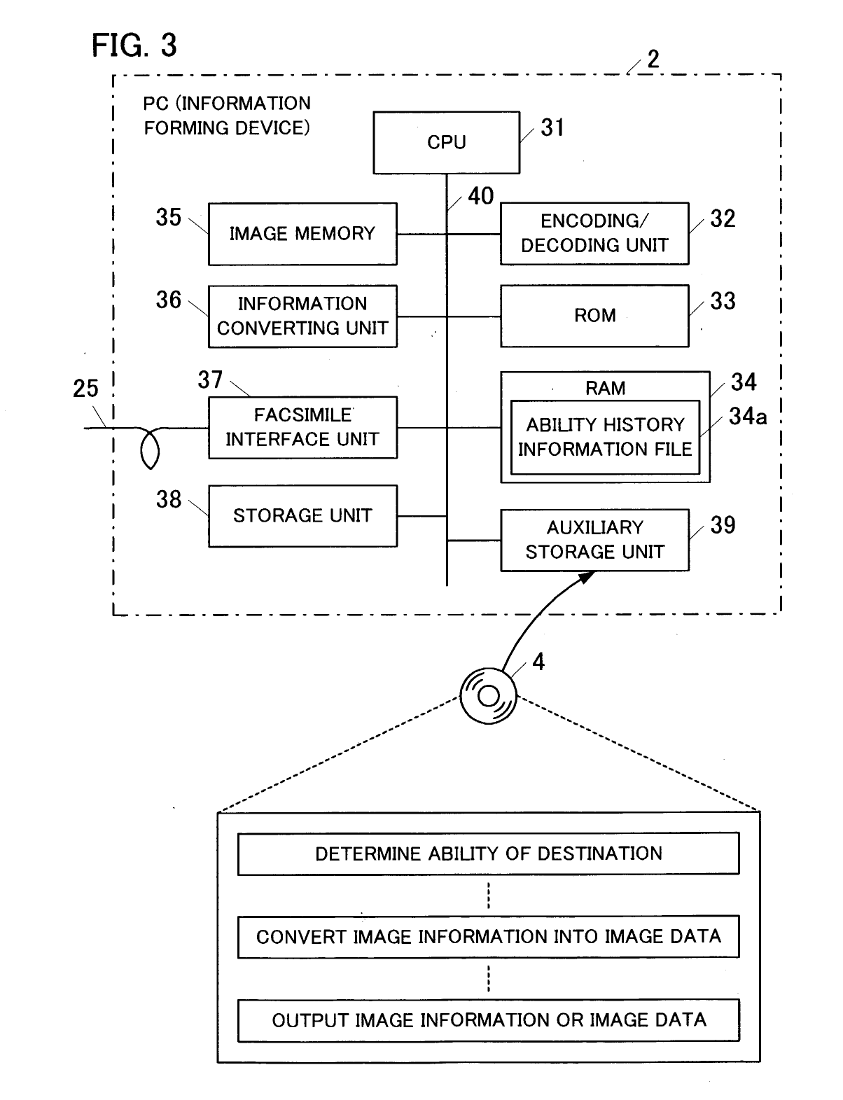

FIG. 3 is a functional block diagram of the PC 2. The PC 2 includes CPU 31, an encoding/decoding unit 32, ROM 33, RAM 34, an image memory 35, an information converting unit 36, a facsimile interface unit 37, a storage unit 38, an auxiliary storage unit 39 or the like.

The CPU 31 is connected to each of the above-described hardware units of the PC 2 via a bus 40. The CPU 31 controls the hardware units in accordance with a control program stored in the ROM 33. The encoding/decoding unit 32 encodes and compresses an image signal, and decodes the encoded and compressed image information into an original image signal.

The ROM 33 stores in advance various software programs that are necessary for controlling the PC 2. The RAM 34 is formed from SRAM, a flash memory or the like. The RAM 34 stores temporarily data that generates when the software is executed. Moreover, the RAM 34 includes an ability history information file 34a. The ability history information file 34a registers information indicating an ability of the facsimile machine 3 of which has communicated with the PC 2 in the past (for example, information indicating whether or not the PDL data can be supported, information indicating a maximum resolution ability, and information indicating a recording width capability), and the facsimile number of the facsimile machine 3. The image memory 35 accumulates formed image information (PDL data), and image data converted from the PDL data, or the like.

The information converting unit 36 converts the formed PDL data into the image data. When necessary, the information converting unit 36 executes a resolution conversion processing to the image data. The facsimile interface unit 37 is connected to the facsimile machine 1 (PC interface unit 22) via the communication line 25. The facsimile interface unit 37 exchanges data with the facsimile machine 1.

A computer program of the present invention is installed in the storage unit 38 formed from a storage device like a hard disk. When the computer program is started, a prescribed part of the computer program is expanded on the RAM 34, and a prescribed processing is executed. The auxiliary storage unit 39 is formed from a Compact Disk-Read Only Memory (CD-ROM) drive that reads the computer program from a recording medium 4 such as the CD-ROM, a Compact Flash memory or anything similar to this that records the computer program of the present invention. The read computer program is stored in the storage unit 38.

Next, the third embodiment of the present invention will be described specifically with reference to the accompanying drawings.

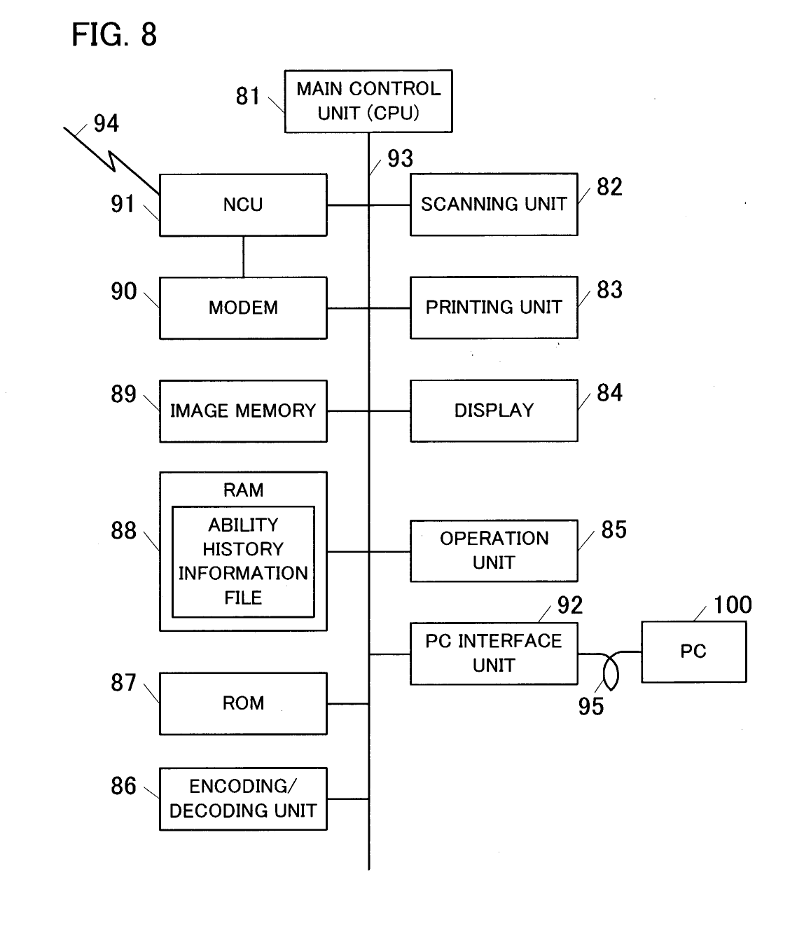

FIG. 8 is a block diagram showing the configuration of the facsimile machine as the communication device of the present invention. The facsimile machine of the present invention includes a main control unit 81, a scanning unit 82, a printing unit 83, a display 84, an operation unit 85, an encoding/decoding unit 86, ROM 87, RAM 88, an image memory 89, a modem 90, NCU 91, and PC interface unit 92 or the like. The facsimile machine of the present invention includes the conventional facsimile functions. In addition, the facsimile machine includes a transmitting function for transmitting image information formed by PC 100 to another facsimile machine as a receiving device by making a connection to the PC 100. The facsimile machine also includes a printer function for printing out the image information by the printing unit 83.

The main control unit 81 is formed from the CPU specifically. The main control unit 81 is connected to each of the above-mentioned hardware units of the facsimile machine via a bus 93, and controls each of the hardware units. In addition, the main control unit 81 executes various software functions in accordance with a control program stored in the ROM 87. The scanning unit 82 scans an original document/image by a scanner using the CCD or the like. In addition, the scanning unit 82 outputs the scanned image data. The printing unit 83 is an electro-photographic printing device. For example, the printing unit 13 prints out image data received by a facsimile communication, the image data of the original document/image scanned by the scanning unit 82, and communication data transmitted from the PC 100.

The display 84 is a displaying device such as a LCD or a CRT display. For example, the display 84 displays an operation status of the facsimile machine of the present invention, the image data of the original document/image scanned to be transmitted, image data received from other facsimile machines, and the communication data transmitted from the PC 100. The operation unit 85 includes letter keys, ten-key numeric pad, speed dial keys, one-touch dial keys, and various function keys or the like that are necessary for operating the facsimile machine of the present invention. Further, by forming the display 84 as a touch panel, a part or all of the various keys within the operation unit 85 can be substituted. The encoding/decoding unit 86 encodes and compresses an image signal, and decodes the encoded and compressed image data into an original image signal.

The ROM 87 stores in advance various software programs that are necessary for the operation of the facsimile machine of the present invention. The RAM 88 is formed from SRAM, a flash memory or the like. The RAM 88 stores temporary data that generates when the software is executed. Moreover, the RAM 88 includes an ability history information file 88a. The ability history information file 88a registers information indicating the ability of the receiving facsimile machine which communicated with the facsimile machine in the past (for example, information indicating whether or not the PDL data can be supported, information indicating a maximum resolution ability, and information indicating a recording width capability), and the facsimile number of the facsimile machine. The image memory 89 is formed from DRAM or the like. For example, the image memory 19 accumulates the image data scanned to be transmitted, the image data received from other facsimile machines, and the communication data transmitted from the PC 100.

The modem 90 is connected to the bus 93. The modem 90 is formed from a facsimile modem that can carry out the facsimile communication. Moreover, the modem 90 is connected directly to the NCU 91 that is also connected to the bus 93 in the same way. The NCU 91 is hardware for carrying out a closing and a releasing operation of a line 94 between the NCU 91 and the telephone network. The NCU 91 connects the modem 90 and the telephone network when necessary.

The PC interface unit 92 is connected to the PC 100 via the communication line 95. The PC interface 92 exchanges data with the PC 100. In addition, the PC interface unit 92 analyzes a command from the PC 100, and executes processing based on the analyzed result. In addition, when necessary, the PC interface 92 converts the image information (PDL data) described in the PDL transmitted from the PC 100 into the image data corresponding to each of a plurality of resolutions.

The line 94 and the line 24 of the first and second embodiments can have similar characteristics. The communication line 95 and the communication line 25 can have similar characteristics.

There are two modes for the operation processing. That is, in a first mode, a conversion of the PDL data into the image data, and when necessary, also the resolution conversion processing is carried out at PC 2 in accordance with the ability (support ability and resolution ability for the PDL data) of the receiving facsimile machine 3. In a second mode, the conversion of the PDL data into image data is carried out at PC 2, and the resolution conversion processing is carried out at the facsimile machine 1 in accordance with the ability (support ability and resolution ability for the PDL data) of the receiving facsimile machine 3. The processing operation of the first mode will be described as the first embodiment, and the processing operation of the second mode will be described as the second embodiment.

(First Embodiment)

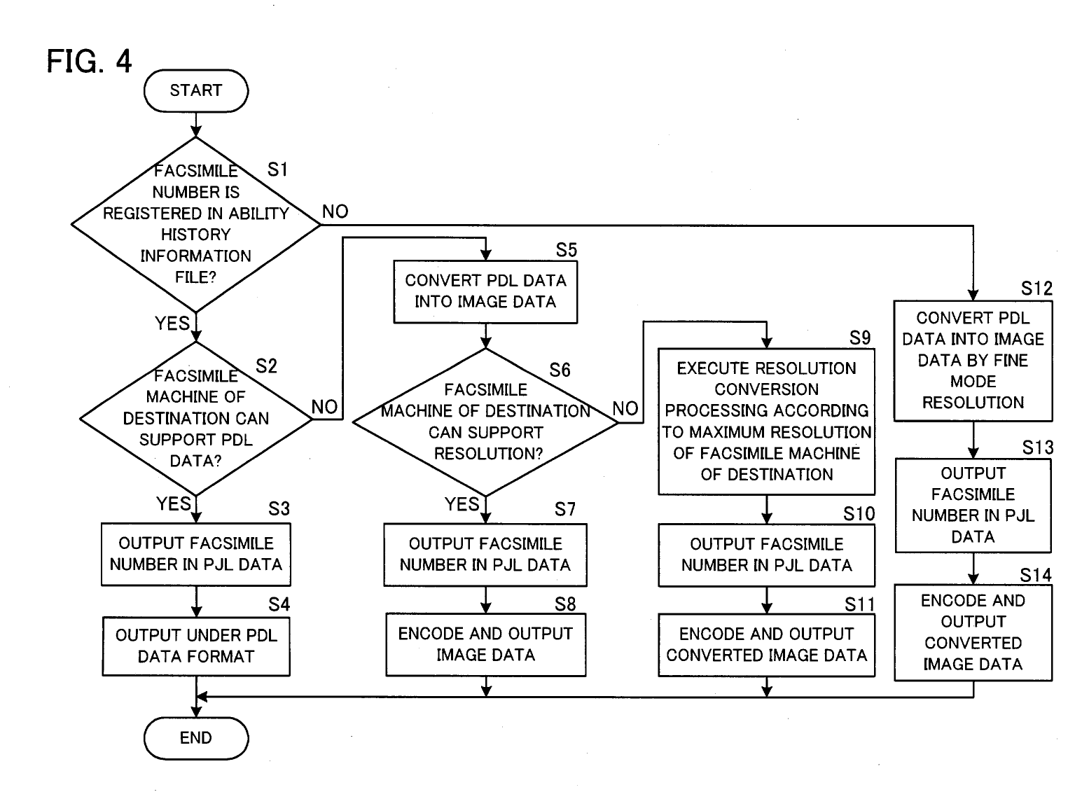

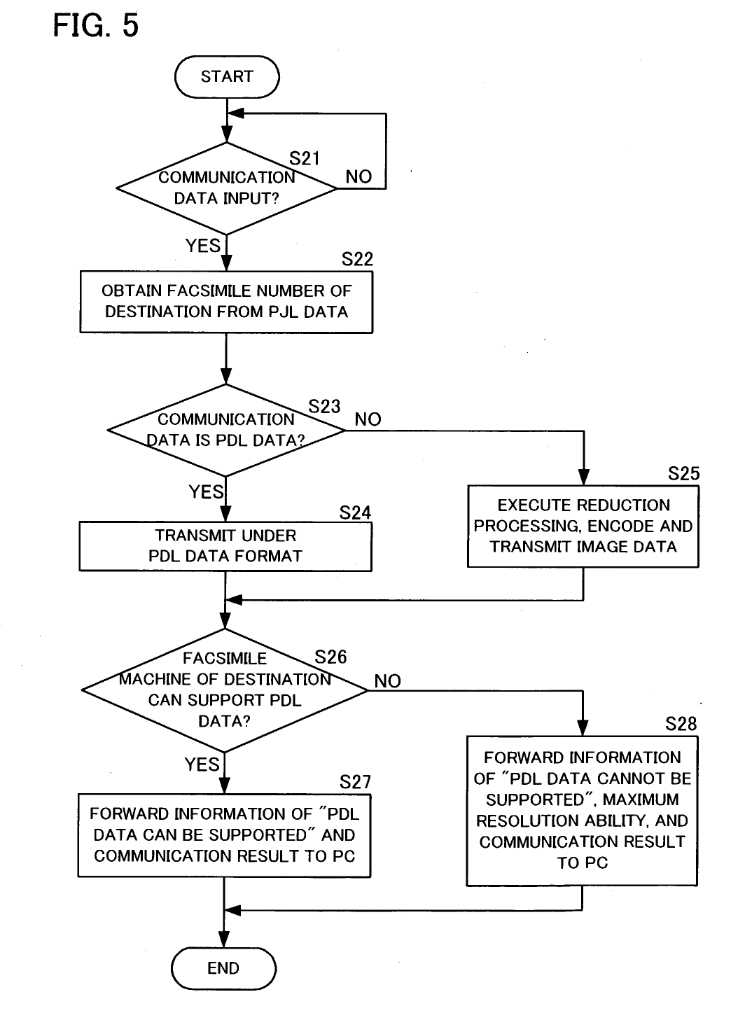

FIG. 4 is a flowchart showing the processing procedure at PC 2 according to the first embodiment. FIG. 5 is a flowchart showing the processing procedure at the facsimile machine 1 side according to the first embodiment.

The CPU 31 determines whether or not the facsimile number of the facsimile machine 3 of the destination is registered in the ability history information file 34a within the RAM 34 (step S1). When the facsimile number is registered (S1: YES), the CPU 31 determines whether or not the receiving facsimile machine 3 can support the PDL data in accordance with the registered contents of the ability history information file 34a (step S2). When the PDL data can be supported (S2: YES), the CPU 31 outputs the facsimile number of the facsimile machine 3 to the facsimile machine 1 as printer job language (PJL) data (step S3). Then, the CPU 31 outputs the formed image information as is under the PDL data format (step S4).

When the PDL data cannot be supported (S2: NO), the CPU 31 converts the PDL data into image data by the information converting unit 36 (step S5). Then, the CPU 31 determines whether or not the receiving facsimile machine 3 can support the resolution of the PDL data in accordance with the registered contents of the ability history information file 34a (step S6). When the resolution can be supported (S6: YES), the CPU 31 outputs the facsimile number of the facsimile machine 3 as the PJL data (step S7). Then, the CPU 31 encodes the converted image data as is, and outputs the encoded image data to the facsimile machine 1 (step S8).

Meanwhile, when the resolution cannot be supported (S6: NO), the CPU 31 executes the resolution conversion processing to the converted image data according to the maximum resolution of which the receiving facsimile machine 3 can support (step S9). Then, the CPU 31 outputs the facsimile number of the facsimile machine 3 as the PJL data (step S10). The CPU 31 encodes the processed image data, and outputs the encoded image data to the facsimile machine 1 (step S11).

When the facsimile number of the receiving facsimile machine 3 is not registered in the ability history information file 34a within the RAM 34 (S1: NO), the CPU 31 converts the PDL data into image data corresponding to a prescribed resolution (fine mode resolution) by the information converting unit 36 (step S12). Then, the CPU 31 outputs the facsimile number of the facsimile machine 3 as PJL data to the facsimile machine 1 (step S13). The CPU 31 encodes the converted image data, and outputs the encoded image data to the facsimile machine 1 (step S14).

The main control unit 11 determines whether or not the communication data is input from the PC 2 (step S21). When the communication data is input (S21: YES), the main control unit 11 obtains the facsimile number of the receiving facsimile machine 3 from the PJL data transmitted from the PC 2 (step S22).

The main control unit 11 determines whether or not the communication data transmitted from the PC 2 is the PDL data (step S23). When the communication data is the PDL data (S23: YES), the main control unit 11 executes a binary file transmission to the receiving facsimile machine 3 under the PDL data format as is (step S24).

When the communication data is not the PDL data, in other words, when the image data is transmitted from the PC 2 (S23: NO), the main control unit 11 obtains the recording width capability of the receiving facsimile machine 3 from the communication protocol. When necessary, the main control unit 11 executes the reduction processing, encodes the image data, and executes the facsimile transmission of the image data to the receiving facsimile machine 3 (step S25).

Then, the main control unit 11 determines whether or not the receiving facsimile machine 3 can support the PDL data in accordance with the communication protocol with the destination (step S26). When the PDL data can be supported (S26: YES), the main control unit 11 forwards the information of the fact that “PDL data can be supported” and the communication result to the PC 2 (step S27). Meanwhile, when the PDL data cannot be supported (S26: NO), the main control unit 11 forwards the information of the fact that “PDL data cannot be supported”, the maximum resolution ability of the facsimile machine 3, and the communication result to PC 2 (step S28).

The information indicating the ability of the facsimile machine 3 forwarded to PC 2 (whether or not the PDL data can be supported, and the maximum resolution), and the facsimile number are registered in the ability history information file 34a within the RAM 34.

In the above-described example, the relay facsimile machine 1 carried out the reduction processing according to the recording width capability of the receiving facsimile machine 3. However, the present invention is not limited to this example, and for example, the information of the recording width capability of each facsimile machine 3 can be registered in the ability history information file 34a, and the PC 2 can also carry out the reduction processing of the image data in addition to the resolution conversion processing.

Moreover, in the above-described processing procedure, when the receiving facsimile machine 3 cannot support the PDL data (S2: NO), first, the PDL data is converted into image data (S5). Then, when the receiving facsimile machine 3 can support the resolution in accordance with the registered contents of the ability history information file 34a (S6: YES), the converted image data is output to the facsimile machine 3 as is (S8). When the receiving facsimile machine 3 cannot support the resolution (S6: NO), the resolution conversion processing is executed (S9), and the image data is output to the facsimile machine 1 (S11). However, the present invention is not limited to this example, and for example, when the receiving facsimile machine 3 cannot support the PDL data (S2: NO), PC 2 can selectively execute a processing to convert the PDL data into image data with no change in resolution, or a processing to convert the PDL data into image data of which the resolution is changed in accordance with the registered contents (ability of the facsimile machine 3) of the ability history information file 34a.

(Second Embodiment)

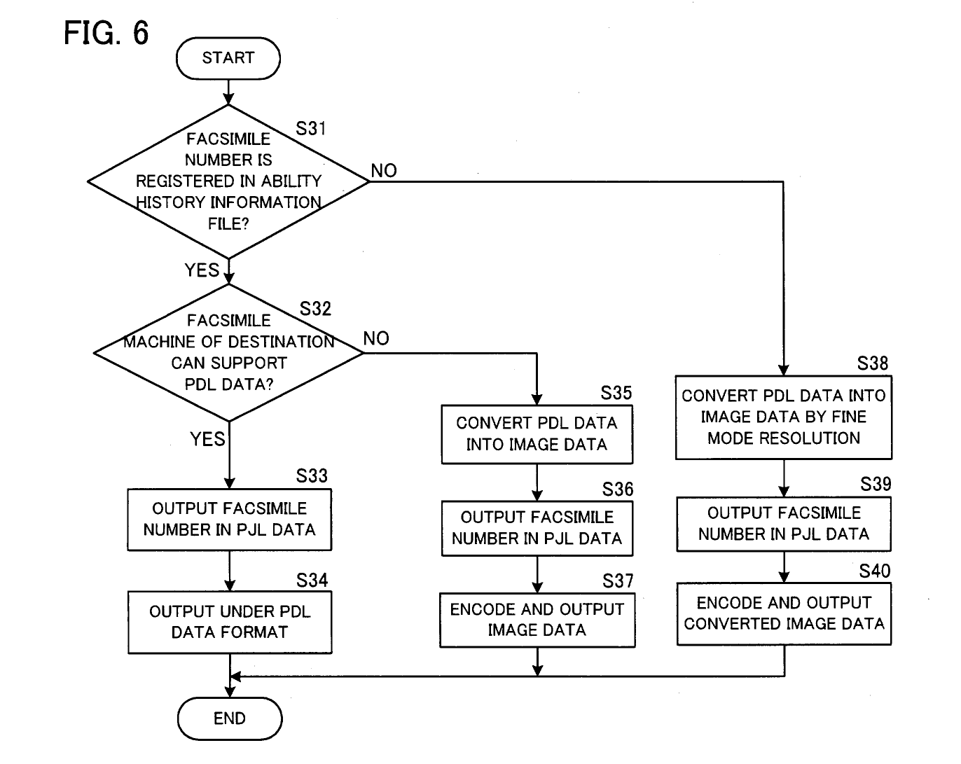

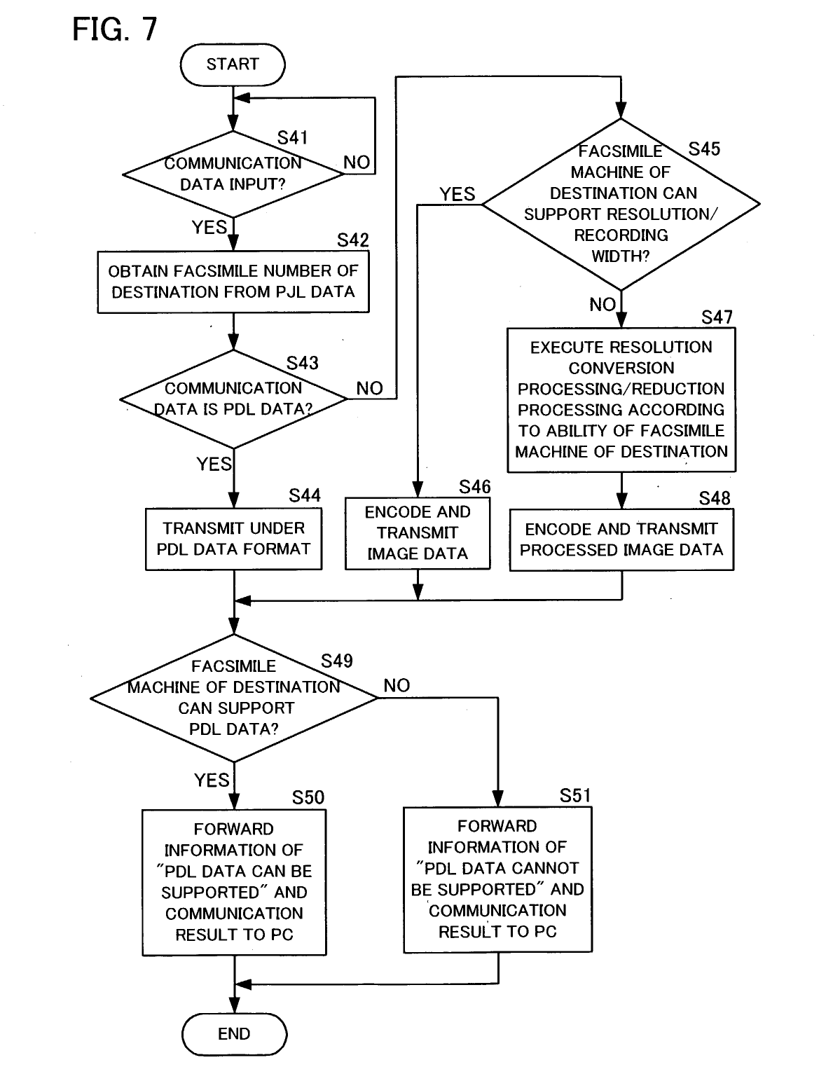

FIG. 6 is a flowchart showing the processing procedure at PC 2 according to the second embodiment. FIG. 7 is a flowchart showing the processing procedure at facsimile machine 1 according to the second embodiment.

The CPU 31 determines whether or not the facsimile number of the receiving facsimile machine 3 is registered in the ability history information file 34a within the RAM 34 (step S31). When the facsimile number is registered (S31: YES), the CPU 31 determines whether or not the receiving facsimile machine 3 can support the PDL data in accordance with the registered contents of the ability history information file 34a (step S32). When the PDL data can be supported (S32: YES), the CPU 31 outputs the facsimile number of the facsimile machine 3 to the facsimile machine 1 as the PDL data (step S33). In addition, the CPU 31 outputs the formed image information to the facsimile machine 1 under the PDL data format (step S34).

When the PDL data cannot be supported (S32: NO), the CPU 31 converts the PDL data into image data by the information converting unit 36 (step S35). Then, the CPU 31 outputs the facsimile number of the facsimile machine 3 to the facsimile machine 1 as the PJL data (step S36). In addition, the CPU 31 encodes the converted image data, and outputs the image data to the facsimile machine 1 (step S37).

When the facsimile number of the receiving facsimile machine 3 is not registered in the ability history information file 34a within the RAM 34 (S31: NO), the CPU 31 converts the PDL data into image data according to a prescribed resolution (fine mode resolution) (step S38). Then, the CPU 31 outputs the facsimile number of the facsimile machine 3 to the facsimile machine 1 as the PJL data (step S39). The CPU 31 encodes the converted image data, and outputs the image data to the facsimile machine 1 (step S40).

The main control unit 11 determines whether or not the communication data is input from the PC 2 (step S41). When the communication data is input (S41: YES), the main control unit 11 obtains the facsimile number of the receiving facsimile machine 3 from the PJL data transmitted from the PC 2 (step S42).

The main control unit 11 determines whether or not the data transmitted from the PC 2 is the PDL data (step S43). When the data is the PDL data (S43: YES), the main control unit 11 executes a binary file transmission to the receiving facsimile machine 3 under the PDL data format (step S44).

When the data is not the PDL data, in other words, when the image data is transmitted from the PC 2 (S43: NO), the main control unit 11 determines whether or not the receiving facsimile machine 3 can support the resolution and the recording width of the input image data (step S45). When the resolution and the recording width can be supported (S45: YES), the main control unit 11 encodes the input image data, and executes a facsimile transmission of the image data to the receiving facsimile machine 3 (step S46).

Meanwhile, when the resolution and/or the recording width cannot be supported (S45: NO), the main control unit 11 executes the resolution conversion processing and/or the reduction processing to the input image data (step S47). Then, the main control unit 11 encodes the processed image data, and executes a facsimile transmission of the image data to the receiving facsimile machine 3 (step S48).

The main control unit 11 determines whether or not the receiving facsimile machine 3 can support the PDL data in accordance with the communication protocol with the destination (step S49). When the PDL data can be supported (S49: YES), the main control unit 11 forwards the information of the fact that “PDL data can be supported” and the communication result to the PC 2 (step S50). Meanwhile, when the PDL data cannot be supported (S49: NO), the main control unit 11 forwards the information of the fact that “PDL data cannot be supported” and the communication result to the PC 2 (step S51).

As described above, the information indicating the ability of the facsimile machine 3 forwarded to the PC 2 (whether or not the PDL data can be supported) is registered with the facsimile number to the ability history information file 34a within the RAM 34.

Further, according to the first and second embodiments, the ability of the receiving facsimile machine 3 is obtained in accordance with the registered contents of the ability history information file 34a. However, the present invention is not limited to this example, and for example, without providing the ability history information file 34a, the PC 2 can obtain the ability of the receiving facsimile machine 3 by the facsimile machine 1 detecting the ability of the receiving facsimile machine 3 from the communication protocol, and transmitting the detected result to the PC 2.

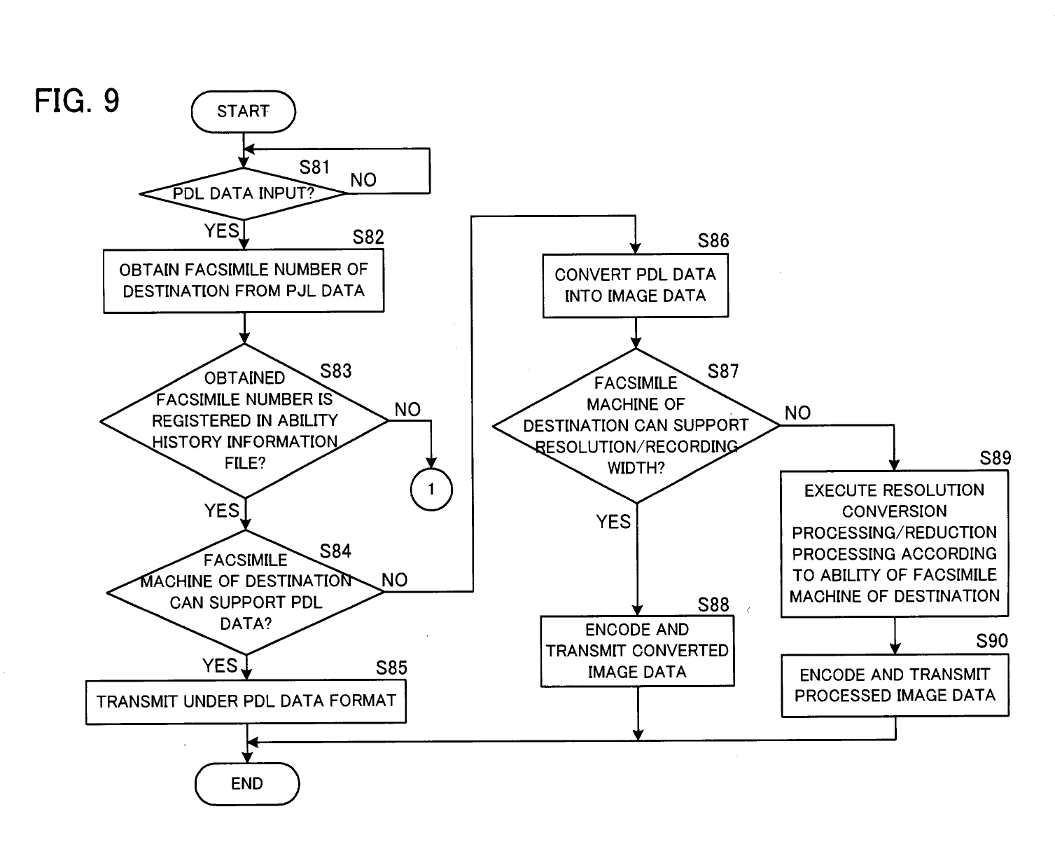

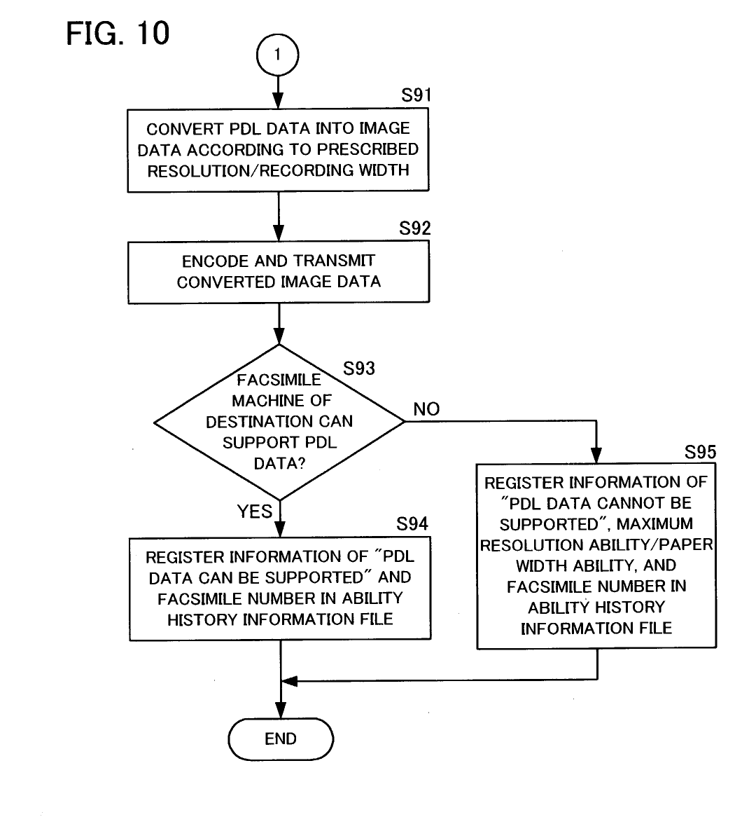

Next, an operation of the facsimile machine according to the third embodiment of the present invention will be described with reference to the flowcharts shown in FIG. 9 and FIG. 10.

The main control unit 81 determines whether or not the PDL data is input from the PC 100 (step S81). When the PDL data is input (S81: YES), the main control unit 81 obtains the facsimile number of the receiving facsimile machine from the PJL data transmitted from the PC 100 (step S82).

The main control unit 81 determines whether or not the obtained facsimile number is registered in the ability history information file 88a within the RAM 88 (step S83). When the facsimile number is registered (S83: YES), the main control unit 81 determines whether or not the receiving facsimile machine can support the PDL data in accordance with the registered contents of the ability history information file 88a (step S84). When the PDL data can be supported (S84: YES), the main control unit 81 executes a binary file transmission to the receiving facsimile machine under the PDL data format (step S85).

When the PDL data cannot be supported (S84: NO), the main control unit 81 converts the PDL data into the image data by the PC interface unit 92 (step S86). Then, the main control unit 81 determines whether or not the receiving facsimile machine can support the resolution and the recording width of the PDL data formed by the PC 100 in accordance with the registered contents of the ability history information file 88a (step S87). When the resolution and the recording width can be supported (S87: YES), the main control unit 81 encodes the converted image data, and executes a facsimile transmission of the image data to the receiving facsimile machine (step S88).

Meanwhile, when the resolution and/or the recording width cannot be supported (S87: NO), the main control unit 81 further executes the resolution conversion processing and/or the reduction processing to the converted image data in accordance with the ability (maximum resolution and recording width capability) of the receiving facsimile machine (step S89). Then, the main control unit 81 encodes the processed image data, and executes a facsimile transmission of the image data to the receiving facsimile machine (step S90).

When the obtained facsimile number is not registered in the ability history information file 88a within the RAM 88 (S83: NO), the main control unit 81 converts the PDL data into an image data corresponding to a prescribed resolution and recording width by the PC interface unit 92 (step S91). The main control unit 81 transmits the converted image data to the receiving facsimile machine (step S92). Then, the main control unit 81 determines whether or not the receiving facsimile machine can support the PDL data in accordance with the communication protocol with the destination (step S93). When the PDL data can be supported (S93: YES), the main control unit 81 registers the information of the fact that “PDL data can be supported” along with the facsimile number of the facsimile machine in the ability history information file 88a within the RAM 88 (step S94). When the PDL data cannot be supported (S93: NO), the main control unit 81 registers the information of the fact that “PDL data cannot be supported” and the maximum resolution ability and the recording width capability of the facsimile machine along with the facsimile number of the facsimile machine in the ability history information file 88a within the RAM 88 (step S95).

As described above, according to the present invention, the ability of the receiving facsimile machine is obtained from the past communication history information. Then, according to the obtained ability, the PDL data as is, the image data converted without a change in the resolution, or the image data converted into a suitable resolution is transmitted to the receiving facsimile machine. Therefore, a processing that is most suitable for the ability of the receiving facsimile machine can be executed, and the processing efficiency can be improved. Moreover, for the destination of which there is no communication history in the past and the ability is unknown, the image data that is converted into a prescribed resolution is transmitted to the receiving facsimile machine. Therefore, the transmission processing to the facsimile machine of such a destination can also be carried out efficiently. Furthermore, for the destination to which the transmission processing is executed for the first time, the ability of the receiving facsimile machine obtained from the communication protocol is registered. Therefore, a processing that is appropriate to the registered contents can be carried out immediately in the next transmission.

Further, according to the above-described processing procedure, when the receiving facsimile machine cannot support the PDL data (S84: NO), the PDL data is converted into image data (S86). When the receiving facsimile machine can support the resolution and the recording width in accordance with the registered contents of the ability history information file 88a (S87: YES), the converted image data is transmitted as is (S88). When the resolution and the recording width cannot be supported (S87: NO), the resolution conversion processing and/or the reduction processing is executed to the converted image data, and the image data is transmitted (S89, S90). However, the present invention is not limited to this example, and for example, when the receiving facsimile machine cannot support the PDL data (S84: NO), a processing to convert the PDL data into image data without changing the resolution and the recording width, or a processing to convert the PDL data into image data of which the resolution and/or the recording width has changed can be executed selectively in accordance with the registered contents (ability of the receiving facsimile machine) of the ability history information file 88a.

Moreover, there are many cases when the ability of the receiving facsimile machine changes according to the change in the type of machine. To comply with such a change, in the above-described example, even for the receiving facsimile machine of which is already registered in the ability history information file 88a, it is preferable to detect the ability of the facsimile machine from the communication protocol, to determine whether or not the detected ability corresponds to the registered contents within the ability history information file 88a, and when the detected ability does not correspond to the registered contents, to update the registered contents. In this case, an appropriate processing can be carried out from the next transmission processing immediately.

Further, in the above-described example, the ability of the receiving facsimile machine is obtained in accordance with the registered contents within the ability history information file 88a. However, the present invention is not limited to this example, and for example, without providing the ability history information file 88a, the ability of the receiving facsimile machine can be detected from the communication protocol with the facsimile machine, and an appropriate processing according to the detected result can be executed.

What is claimed is:

1. A communication system comprising:
means for transmitting formed data formed by an information forming device, or converted data of which a format of the formed data is converted, to a receiving device via a communication device;
wherein the information forming device includes means for determining an ability of the receiving device, and means for selecting either the formed data or the converted data in accordance with the determined ability and outputting the selected data to the communication device.

2. A computer program comprising:
outputting communication data based on image information to be transmitted to a receiving device to a communication device by a computer connected to the communication device;
determining an ability of the receiving device by the computer; and
deciding a format of the communication data by the computer in accordance with the determined ability.

3. The computer program according to claim 2, further comprising:
determining whether or not the receiving device can support a page description language by the computer; and
outputting the image information described in the page description language as the communication data to the communication device by the computer when the receiving device can support the page description language.

4. The computer program according to claim 3, further comprising:
converting the image information described in the page description language into image data corresponding to a resolution of the receiving device by the computer when the receiving device cannot support the page description language; and
outputting the converted image data as the communication data to the communication device by the computer.

5. The computer program according to claim 3, further comprising:
converting the image information described in the page description language into image data by the computer when the receiving device cannot support the page description language; and
outputting the converted image data as the communication data to the communication device by the computer.

6. A communication device comprising:
means for transmitting image information or image data to a receiving device specified by destination information when the image information or the image data converted from the image information and the destination information are input from an information forming device that forms the image information described in a page description language; and
means for transmitting an ability of the receiving device to the image forming device.

7. A control method of a communication device comprising:
inputting image information or an image data converted from the image information and destination information from an information forming device which forms the image information described in a page description language;
transmitting the image information or the image data to a receiving device specified by the destination information; and
transmitting an ability of the receiving device to the image forming device.

8. The communication device according to claim 6, further comprising:
means for transmitting the image information to the receiving device when the image information is input from the information forming device; and
means for executing a resolution conversion processing to the image data in accordance with a resolution of the receiving device obtained from a communication protocol with the receiving device and transmitting the image data to the receiving device when the image data is input from the information forming device.

9. The control method of the communication device according to claim 7, further comprising:
transmitting the image information to the receiving device when the image information is input from the information forming device; and
executing a resolution conversion processing to the image data in accordance with a resolution of the receiving device obtained from a communication protocol with the receiving device and transmitting the image data to the receiving device when the image data is input from the information forming device.

10. A communication device comprising:
means for inputting communication data described in a page description language;
means for obtaining destination information of the input communication data;
means for determining whether or not a receiving device specified by the destination information can support the page description language; and
means for transmitting the input communication data to the receiving device when the specified receiving device can support the page description language.

11. A control method of a communication device comprising the steps of:
inputting communication data described in a page description language;
obtaining destination information of the input communication data;
determining whether or not a receiving device specified by the destination information can support the page description language; and
transmitting the input communication data to the receiving device when the specified receiving device can support the page description language.

12. The communication device according to claim 10, further comprising:
means for determining whether or not the receiving device can support a resolution of the communication data when the receiving device cannot support the page description language;
means for converting the communication data into an image data when the receiving device can support the resolution; and
means for transmitting the converted image data to the receiving device under the resolution.

13. The control method of the communication device according to claim 11, further comprising:
determining whether or not the receiving device can support a resolution of the communication data when the receiving device cannot support the page description language;
converting the communication data into image data when the receiving device can support the resolution; and
transmitting the converted image data to the receiving device under the resolution.

14. The communication device according to claim 12, further comprising:
means for converting the input communication data into an image data corresponding to the resolution of the receiving device when the receiving device cannot support the resolution of the communication data; and
means for transmitting the converted image data to the receiving device.

15. The control method of the communication device according to claim 13, further comprising:
converting the input communication data into an image data corresponding to the resolution of the receiving device when the receiving device cannot support the resolution of the communication data; and
transmitting the converted image data to the receiving device.

16. The communication device according to claim 10, further comprising:
means for converting the input communication data into image data corresponding to a prescribed resolution when a fact of whether or not the receiving device can support the page description language is unclear; and
means for transmitting the converted image data to the receiving device.

17. The control method of the communication device according to claim 11, further comprising:
converting the input communication data into image data corresponding to a prescribed resolution when a fact of whether or not the receiving device can support the page description language is unclear; and
transmitting the converted image data to the receiving device.

18. A communication system comprising:
a transmitter that transmits formed data formed by an information device or converted data of which a format of the formed data is converted, to a receiving device via a communication device;
wherein the information forming device includes a processor that determines an ability of the receiving device and a controller that selects either the formed data or the converted data in accordance with the determined ability and outputting the selected data to the communication device.

19. The communication system according to claim 1, wherein the formed image data is page description language (PDL) data.

20. The communication system according to claim 19, further comprising a processor for determining whether or not the receiving device can support a resolution of communication data when the receiving device cannot support the PDL data.
